(19) United States
(12) Patent Application Publication
(10) Pub. No.: US 2007/0002945 A1
(43) Pub. Date: Jan. 4, 2007

(54) INTRA-CODING APPARATUS AND METHOD

(76) Inventor: Eung-Tae KIM, Suwon-si (KR)

Correspondence Address: HARNESS, DICKEY & PIERCE, P.L.C., P.O. BOX 8910, RESTON, VA, 20195, US

(21) Appl. No.: 11/425,878

(22) Filed: Jun. 22, 2006

(30) Foreign Application Priority Data
Jun. 29, 2005 (KR) 10-2005-0057201

(51) Int. Cl. H04B 1/66

(52) U.S. Cl. 375/240

(57) ABSTRACT

An intra-coding apparatus and method for coding an image including a plurality of macroblocks are provided. The intra-coding apparatus includes an intra-frame prediction unit determining an intra prediction mode using border pixels on borders between a current macroblock to be coded and adjacent macroblocks and generating a predicted macroblock corresponding to the current macroblock in the determined intra prediction mode; a subtractor outputting a difference between the current macroblock and the predicted macroblock; a transformation/quantization unit transforming the difference into a frequency band signal and quantizing the frequency band signal; and a coding unit coding a quantization result.

### BACKGROUND OF THE INVENTION

This application claims the priority of Korean Patent-Application No. 10-2005-0057201, filed on Jun. 29, 2005, in the Korean Intellectual Property Office, the disclosure of which is incorporated herein in its entirety by reference.

1. Field of the Invention

The present invention relates to an intra-coding method and apparatus, and more particularly, to an intra-coding method and apparatus for H.264/Motion Picture Experts Group (MPEG)-4 Advanced Video Coding (AVC).

2. Description of the Related Art

Recently, products and communication media for digital video services have been rapidly developed. In particular, video application technology using video standards such as an MPEG standard or an H.264 standard provides video services even to home through an Asynchronous Transfer Mode (ATM) or over-the-air communication. To provide various video services using conventional communication media, a coding method for efficient video compression is required. In particular, since the H.264 standard provides a higher compression rate-than that provided by an MPEG-2 standard, various compression methods for improved picture quality have been introduced. An example of the various compression methods has been introduced by Wigand et al. [“Overview of the H.264/AVC Video Coding Standard”, IEEE trans. on Circuits and Systems for Video Tech., vol. 13, no. 7, pp. 560-576, July 2003].

In addition, the H.264 standard introduces intra-frame prediction in intra-picture coding to achieve a higher compression rate than that achieved by the MPEG-2 standard using discrete cosine transform (DCT) and variable length coding (VLC) in units of macroblocks having a size of 16×16 pixels. In the intra-frame prediction, only a difference between a pixel value to be coded and a predicted pixel value obtained through spatial prediction using neighboring pixel values that have been coded is coded.

In H.264 AVC intra-coding, two intra-macroblock prediction modes, i.e., an intra 4×4 mode and an intra 16×16 mode exist for a luminance component. In the intra 4×4 mode, a macroblock is divided into 4×4 sub-blocks and predicted values are generated using nine prediction modes, i.e., mode 0 to mode 8 with respect to each sub-block. After predicted values for 16 pixels in a current sub-block are generated using the nine prediction modes, differences between actual pixel values and the corresponding predicted pixel values in the current sub-block are obtained and a cost function is calculated using the obtained differences. In this manner, cost functions are respectively calculated by performing the nine prediction modes with respect to a single sub-block, and one prediction mode giving the least cost function is determined. After prediction for one sub-block is finished, prediction for another one is executed until all of the sub-blocks are subjected to the prediction.

In the intra 16×16 mode, predicted values are generated in four prediction modes, i.e., mode 0 to mode 3, respectively, with respect to each macroblock. In other words, the four prediction modes are performed with respect to a 16×16 macroblock and one prediction mode giving the least cost function is determined.

In H.264 intra-frame prediction, more bits are required to express intra 4×4 mode information than to express intra 16×16 mode information. Usually, the intra 4×4 mode is used to express very high texture and the intra 16×16 mode is used to express a flat region not including an edge.

Unlikely, to determine an intra-frame prediction mode for a current macroblock in H.264 AVC, cost functions are calculated in the nine 4×4 prediction modes and the four 16×16 prediction modes, i.e., a total of 13 predictions modes; an intra-macroblock block is generated in a mode giving the least cost function among the 13 prediction modes; and intra-coding is performed using the intra-macroblock. Accordingly, a large amount of calculation is required in the conventional intra-coding.

### SUMMARY OF THE INVENTION

According to an aspect of the present invention, there is provided an intra-coding apparatus for coding an image comprised of a plurality of macroblocks. The intra-coding apparatus includes an intra-frame prediction unit determining an intra prediction mode using border pixels on borders between a current macroblock to be coded and adjacent macroblocks and generating a predicted macroblock corresponding to the current macroblock in the determined intra prediction mode; a subtractor outputting a difference between the current macroblock and the predicted macroblock; a transformation/quantization unit transforming the difference into a frequency band signal and quantizing the frequency band signal; and a coding unit coding a quantization result.

According to another aspect of the present invention, there is provided an intra-coding method for coding an image comprised of a plurality of macroblocks. The intra-coding method includes detecting whether border pixels on borders between a current macroblock to be coded and adjacent macroblocks include an edge; calculating an edge direction in the border pixels in a prediction mode determined according to a result of the detection and determining an intra prediction mode based on a result of the calculation; generating a predicted macroblock corresponding to the current macroblock in the intra prediction mode; and calculating a difference between the current macroblock and the predicted macroblock and coding the calculated difference.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a video coding apparatus using an intra-coding method according to an exemplary embodiment of the present invention; FIG. 2 illustrates adjacent pixels on borders of adjacent blocks;

FIG. 3 is a detailed block diagram of an intra-frame prediction unit illustrated in FIG. 1;

FIG. 4 is a flowchart of a method of generating a predicted macroblock according to an exemplary embodiment of the present invention;

FIG. 5 illustrates edge directions in an intra 16×16 prediction mode;

FIG. 6 illustrates edge directions in an intra 4×4 prediction mode;

FIG. 7 illustrates the corresponding relationship between pixels in a vertical edge direction in the intra 4×4 prediction mode;

FIG. 8 illustrates the corresponding relationship between pixels in a horizontal edge direction in the intra 4×4 prediction mode; and

FIG. 9 illustrates the coding order of 4×4 sub-blocks in a macroblock in an exemplary embodiment of the present invention.

### DETAILED DESCRIPTION OF THE INVENTION

Hereinafter, exemplary embodiments of the present invention will be described in detail with reference to the attached drawings. Like reference numerals in the drawings denote the like elements.

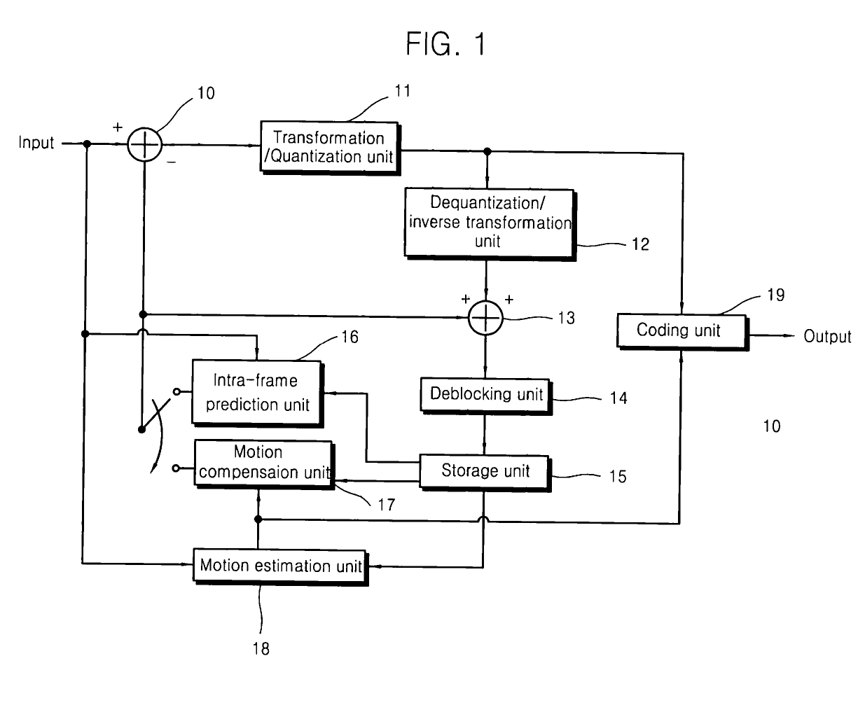

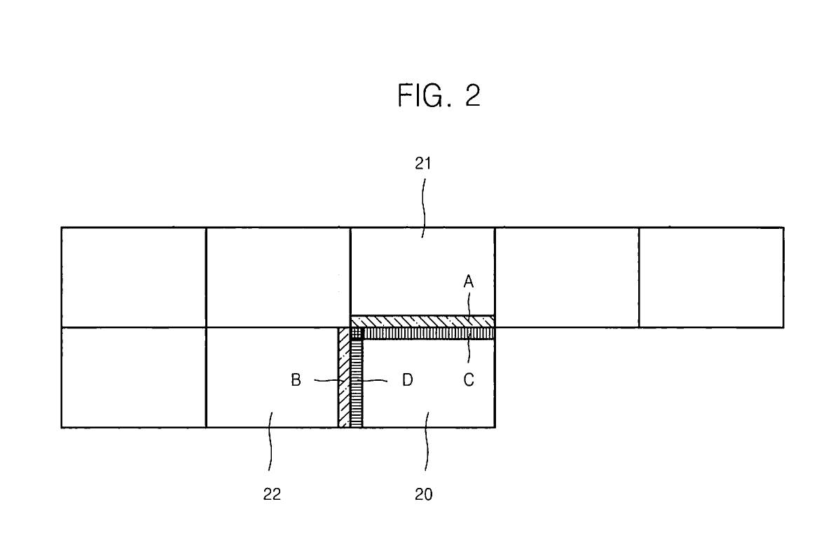

FIG. 1 is a block diagram of a video coding apparatus using an intra-coding method according to an exemplary embodiment of the present invention. The video coding apparatus includes a first adder 10, a transformation/quantization unit 11, a dequantization/inverse-transformation unit 12, a second adder 13, a deblocking unit 14, a storage unit 15, an intra-frame prediction unit 16, a motion compensation unit 17, a motion estimation unit 18, and a coding unit 19.

The video coding apparatus processes an image input in units of macroblocks having a size of 16×16 pixels. A plurality of macroblocks are encapsulated in a slice. A single frame includes a plurality of slices according to an image size.

In intra-coding, the first adder 10 outputs a difference between an input macroblock and a predicted macroblock output from the intra-frame prediction unit 16. The intra-frame prediction unit 16 generates the predicted macroblock using a macroblock coded and reconstructed with respect to a previous frame stored in the storage unit 15 and outputs the predicted macroblock. The operation of the intra-frame prediction unit 16 will be described in detail later.

The transformation/quantization unit 11 converts the difference between the current macroblock and the predicted macroblock, output from the first adder 10, into a frequency band signal using discrete cosine transform (DCT) and quantizes converted DCT coefficients. The coding unit 19 entropy codes the quantized DCT coefficients using, for example, variable length coding (VLC) or context-adaptive VLC, and outputs coded DCT coefficients.

The dequantization/inverse-transformation unit 12 performs dequantization (inverse-quantization) and inverse DCT of the quantized DCT coefficients. The second adder 13 adds a result of the inverse DCT to the predicted macroblock output from the intra-frame prediction unit 16. Since the image is coded in units of macroblocks, a blocking effect occurs due to a quantization difference between macroblocks. To remove the blocking effect, the deblocking unit 14 performs deblocking filtering. A filtered and recovered macroblock is stored in the storage unit 15 and is used to predict a next macroblock.

Inter-coding is implemented by performing motion compensation of one macroblock most similar to a current macroblock among macroblocks in a reference frame based on a motion vector estimated by comparing the current macroblock with the macroblocks in the reference frame. For this inter-coding, the motion estimation unit 18 performs motion estimation of the input macroblock with respect to the reference frame stored in the storage unit 15 to output motion data including the motion vector and an index indicating the reference frame. Here, the reference frame may be an intra-picture (I-picture) or a predictive-picture (P-picture) in Motion Picture Experts Group (MPEG)-2 and may be any one among an I-picture, a P-picture, and a Bi-directional predictive picture (B-picture) in H.264.

Based on the motion data output from the motion estimation unit 18, the motion compensation unit 17 extracts a macroblock corresponding to the input macroblock from the reference frame used for the motion estimation. The first adder 10 subtracts the motion-compensated macroblock from the input macroblock to obtain a difference therebetween. The transformation/quantization unit 11 performs DCT and quantization of an output of the first adder 10. The coding unit 19 entropy codes the quantized DCT coefficients and the motion vector estimated by the motion estimation unit 18, thereby outputting a compressed bitstream.

The present invention is provided to generate a predicted macroblock with a reduced amount of calculation in the intra-frame prediction unit 16 without deterioration of coding performance and to perform intra-coding using the predicted macroblock. In the conventional intra-coding, as described above, prediction is performed in a total of 13 modes, i.e., nine intra 4×4 prediction modes and four 16×16 prediction modes; a mode giving the least cost function among the 13 modes is determined as an intra prediction mode for a current macroblock; and a predicted macroblock is generated in the determined mode. However, in the present invention, which of an intra 16×16 mode and an intra 4×4 mode will be used to predict a macroblock is determined first.

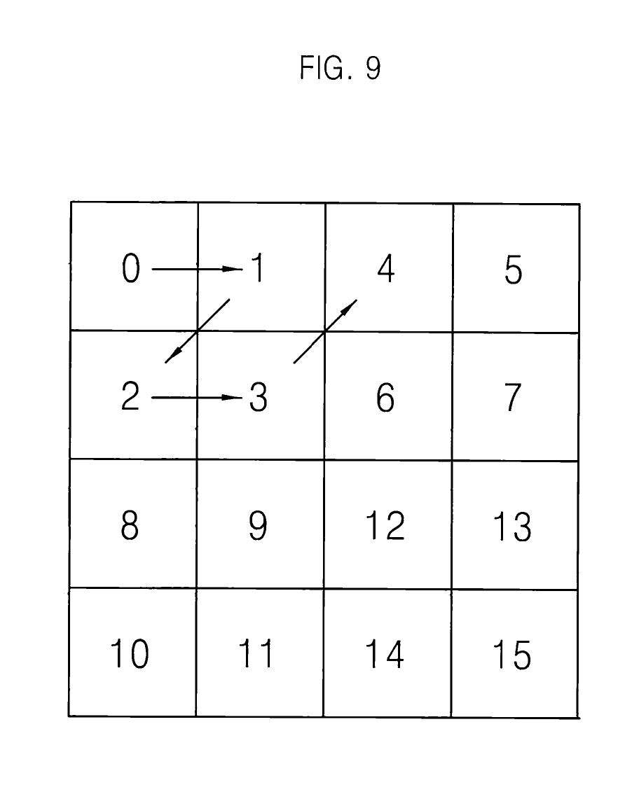

In an exemplary embodiment of the present invention, A and B pixels in adjacent blocks are used to determine a prediction mode, as illustrated in FIG. 2. Here, the adjacent blocks include an upper macroblock 21 and a left macroblock 22 of a current macroblock 20. The upper macroblock 21 and the left macroblock 22 have already been coded through the operations of the first adder 10 and the transformation/quantization unit 11, reconstructed through the operations of the dequantization/inverse-transformation unit 12, the second adder 13, and the deblocking unit 14, and then stored in the storage unit 15. FIG. 9 illustrates the coding order of 4×4 sub-blocks in a macroblock in an exemplary embodiment of the present invention. Coding of the sub-blocks is performed in numerical order. Accordingly, it can be inferred that upper and left macroblocks of a current macroblock have been coded and reconstructed completely.

In exemplary embodiments of the present invention, it is determined whether borders of blocks include an edge using the A and B pixels in the adjacent macroblocks 21 and 22 and C and D pixels in the current macroblock 20. Since the intra 4×4 prediction mode is used for a high-texture region including a high-frequency component like an edge and the intra 16×16 prediction mode is used for a flat region not including an edge, a prediction mode can be determined by detecting the existence or non-existence and the direction of an edge using pixel values at a border of a macroblock in exemplary embodiments of the present invention. The A, B, C, and D pixels on the borders between the current macroblock 20 and the adjacent macroblocks 21 and 22 are referred to as “border pixels”.

When the current macroblock 20 is located on the first row of an image, the A pixels do not exist. In this case, predetermined DC values are used as values of the A pixels. Similarly, when the current macroblock 20 is located on the first column of the image, the B pixels do not exist, and therefore, predetermined DC values are used as values of the B pixels. An intra prediction mode is determined using only the C and D pixels on the border of the current macroblock 20.

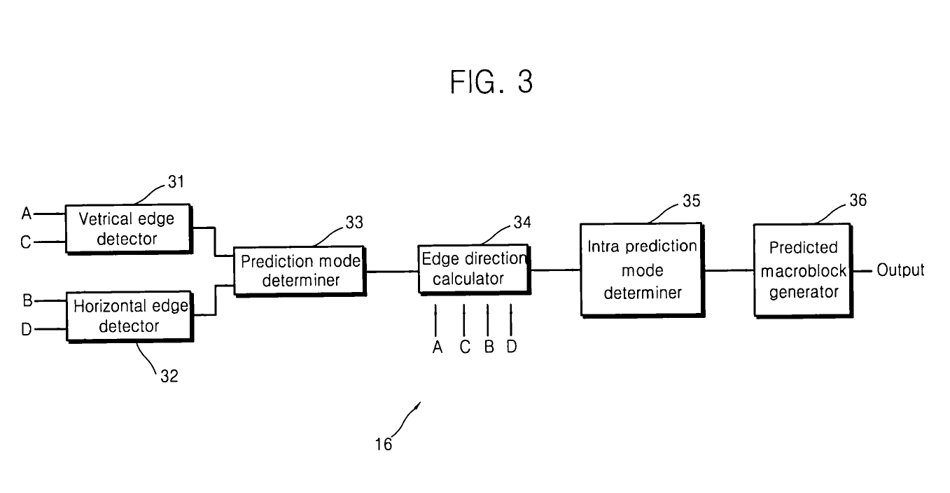

FIG. 3 is a detailed block diagram of the intra-frame prediction unit 16 illustrated in FIG. 1. The intra-frame prediction unit 16 includes a vertical edge detector 31, a horizontal edge detector 32, a prediction mode determiner 33, an edge direction calculator 34, an intra prediction mode determiner 35, and a predicted macroblock generator 36.

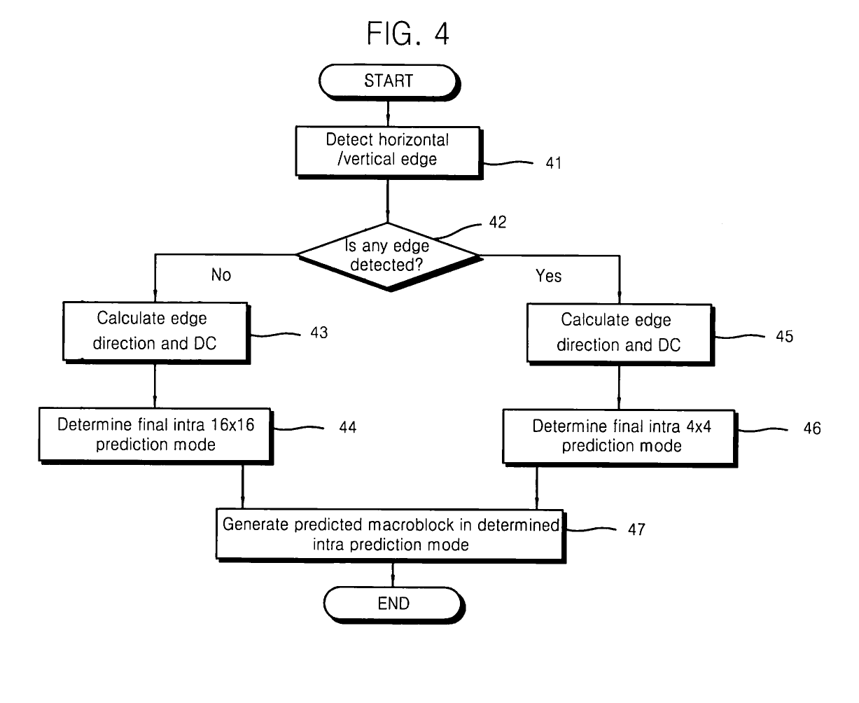

The operation of the intra-frame prediction unit 16 illustrated in FIG. 3 will be described with reference to FIG. 4, which is a flowchart of a method of generating a predicted macroblock according to an exemplary embodiment of the present invention.

In operation 41, the vertical edge detector 31 detects existence or non-existence of a vertical edge using the adjacent A pixels in the upper macroblock 21 and the adjacent C pixels in the current macroblock 20 and the horizontal edge detector 32 detects existence or non-existence of a horizontal edge using the adjacent B pixels in the left macroblock 22 and the adjacent D pixels in the current macroblock 20.

To detect the vertical edge, a largest value among absolute values of differences between the corresponding adjacent A and C pixels in a vertical direction is found using Equation (1):

$$Max\_V = \begin{matrix}max \\ i\end{matrix} {\vert A ( i ) - C ( i ) \vert}_{i = 0 , ⋯ , N - 1} , \qquad ( 1 )$$

where N is the number of border pixels in each macroblock in the vertical direction.

When the largest value Max_V is equal to or greater than a first threshold value Th_V, the vertical edge detector 31 determines that an edge exists between the vertically adjacent A and C pixels.

To detect the horizontal edge, a largest value among absolute values of differences between the corresponding adjacent B and D pixels in a horizontal direction is found using Equation (2):

$$Max\_H = \begin{matrix}max \\ i\end{matrix} {\vert B ( i ) - D ( i ) \vert}_{i = 0 , ⋯ , M - 1} , \qquad ( 2 )$$

where M is the number of border pixels in each macroblock in the horizontal direction.

When the largest value Max_H is equal to or greater than a first threshold value Th_H, the horizontal edge detector 32 determines that an edge exists between the horizontally adjacent B and D pixels.

In operation 42, the prediction mode determiner 33 selects one mode between an intra 4×4 prediction mode and an intra 16×16 prediction mode using the values Max_V and Max_H calculated by the vertical and horizontal edge detectors 31 and 32 based on conditions defined by Equation (3):
If(Max_H<Th_H && Max_V<Th_V)
perform intra 16×16 prediction mode
Else
perform intra 4×4 prediction mode, (3)
where Th_H and Th_V are threshold values used to detect horizontal and vertical edges, respectively.

According to Equation (3), if any one of horizontal and vertical edges is detected, the intra 4×4 prediction mode is performed. If no edge is detected, the intra 16×16 prediction mode is performed.

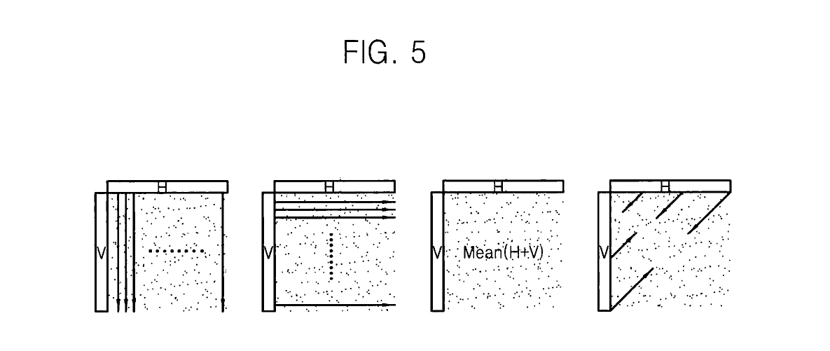

When the intra 16×16 prediction mode is performed, the edge direction calculator 34 calculates cost functions for a vertical direction in mode 0, a horizontal direction in mode 1, a DC direction in mode 2, and a plane direction in mode 3, respectively, as illustrated in FIG. 5, using only values of the A, B, C, and D pixels in operation 43. In FIG. 5, an arrow indicates a prediction direction, i.e., an edge direction in each mode.

A cost function, i.e., the sum of absolute difference (SAD) in each of the vertical mode, the horizontal mode, and the DC mode can be obtained using Equation (4):

$$SAD\_V = {\sum }_{i = 0}^{N - 1} \vert A ( i ) - C ( i ) \vert \\ SAD\_H = {\sum }_{i = 0}^{M - 1} \vert B ( i ) - D ( i ) \vert \\ SAD\_DC = \frac{( {\sum }_{i = 0}^{N - 1} \vert C ( i ) - D C \vert + {\sum }_{i = 0}^{M - 1} \vert D ( i ) - D C \vert )}{2} , \qquad ( 4 )$$

where N and M are 16 and DC is the mean of the A and B pixels.

In the current embodiment of the present invention, the SAD is used as the cost function. However, any one among the sum of absolute transformed difference (SATD), the sum of squared difference (SSD), and the mean of absolute difference (MAD) may also be used as the cost function in the present invention.

For the cost function in the plane mode, a value SAD_Plane is calculated by performing bilinear transform of the C and D pixels when a difference is calculated.

In operation 44, the intra prediction mode determiner 35 determines a mode corresponding to the least value among the values SAD_V, SAD_H, SAD_DC, and SAD_Plane as a final intra 16×16 prediction mode. In operation 47, the predicted macroblock generator 36 generates a predicted macroblock in the determined final intra prediction mode.

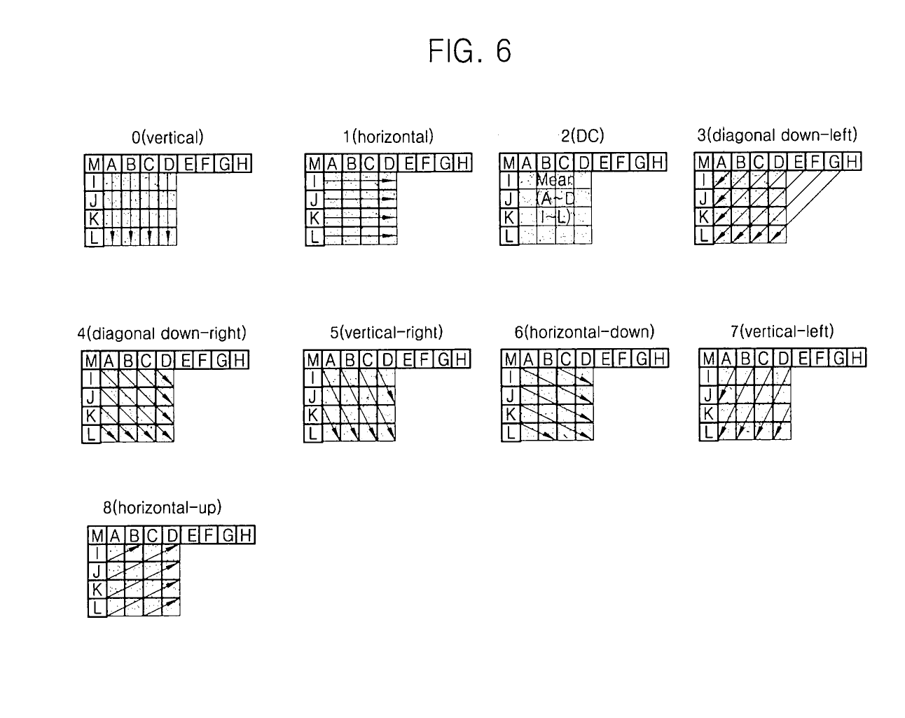

Meanwhile, when the prediction mode determiner 33 selects the intra 4×4 prediction mode, the edge direction calculator 34 respectively calculates cost functions for more edge directions in the intra 4×4 prediction mode than in the intra 16×16 prediction mode. FIG. 6 illustrates edge directions in the intra 4×4 prediction mode. In operation 45, the edge direction calculator 34 calculates cost functions, i.e., SADs for a vertical direction in mode 0, a horizontal direction in mode 1, a DC direction in mode 2, a diagonal down-left direction in mode 3, a diagonal down-right direction in mode 4, a vertical-right direction in mode 5, a horizontal-down direction in mode 6, a vertical-left direction in mode 7, and a horizontal-up direction in mode 8, respectively. Conventionally, cost functions are calculated with respect to all of pixels in a 4×4 block. However, in the present invention, cost functions are calculated with respect only to border pixels in the 4×4 block, whereby the amount of calculation is reduced.

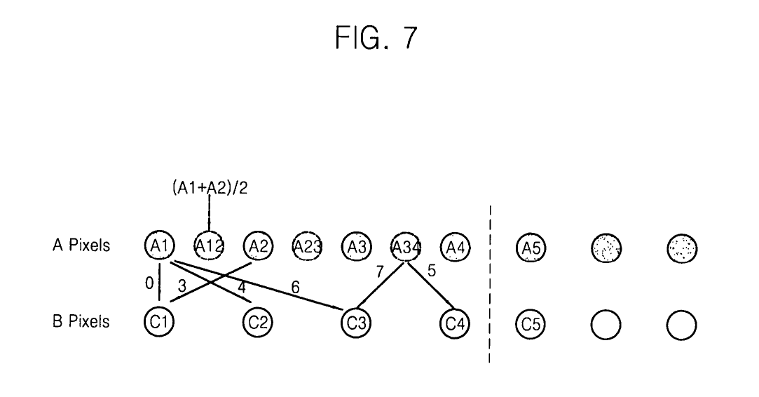

FIG. 7 illustrates the corresponding relationship between pixels in a vertical edge direction in the intra 4×4 prediction mode. Referring to FIG. 7, with respect to the vertical edge direction, cost functions in modes 0, 3, 4, 5, 6, and 7 among the prediction modes illustrated in FIG. 6 can be calculated.

In mode 0, a value SAD_0 is calculated with respect to four pixel pairs (A1,C1), (A2,C2), (A3,C3), and (A4,C4) in the same manner as the value SAD_V is calculated in Equation (4). In mode 3, a value SAD_3 is calculated using pixel pairs (A2,C1), (A3,C2), (A4,C3), and (A5,C4). In mode 4, a value SAD_4 is calculated using pixel pairs (A0,C1), (A1,C2), (A2,C3), and (A3,C4). Although not shown in FIG. 7, the pixel A0 is the left adjacent pixel of the pixel A1. In mode 6, a value SAD_6 is calculated using pixels paired like (A1,C3). In mode 5, a value SAD_5 is calculated using pixel pairs (A01,C1), (A12,C2), (A23,C3), and (A34,C4). In mode 7, a value SAD_7 is calculated using pixels paired like (A34,C3). Here, the pixel A12 is (A1 +A2)/2 and the pixels A23, A34, and A01 may be obtained in the same manner.

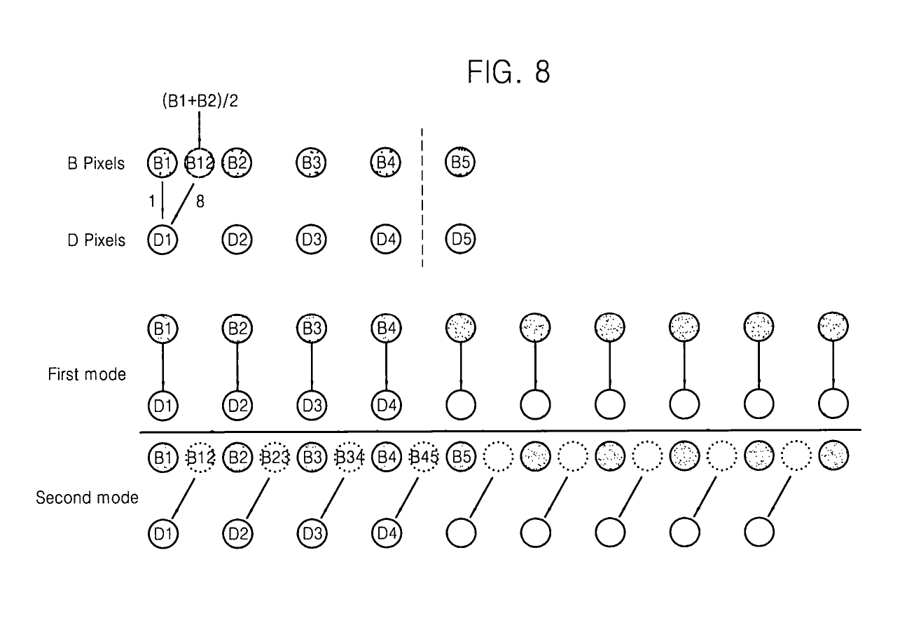

FIG. 8 illustrates the corresponding relationship between pixels in a horizontal edge direction in the intra 4×4 prediction mode. Referring to FIG. 8, with respect to the horizontal edge direction, cost functions in modes 1 and 8 among the prediction modes illustrated in FIG. 6 can be calculated. In the calculation for the horizontal edge direction, the B and D pixels are used. In mode 1, a value SAD_1 is calculated using pixel pairs (B1,D1), (B2,D2), (B3,D3), and (B4,D4). In mode 8, a value SAD_8 is calculated using pixel pairs (B12,D1), (B23,D2), (B34,D3), and (B45,D4). The values SAD_1 and SAD_8 are calculated in the same manner as the value SAD_H is calculated in Equation (4). Here, the pixel B12 is (B1+B2)/2 and the pixels B23, B34, and B45 may be obtained in the same manner. With respect to the DC direction in mode 2, a value SAD_2 can be calculated in the same manner as the value SAD_DC is calculated in Equation (4) where N=M=4.

In operation 46, the intra prediction mode determiner 35 determines a mode corresponding to the least value among the values SAD_0 through SAD_8 as a final intra 4×4 prediction mode. In operation 47, the predicted macroblock generator 36 generates a predicted macroblock in the determined final intra prediction mode.

A difference between the predicted macroblock and the current macroblock 20 (FIG. 2) is calculated using the first adder 10 illustrated in FIG. 1. The transformation/quantization unit 11 performs DCT and quantization of an output of the first adder 10. The coding unit 19 codes a quantization result to generate a bitstream.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the present invention, for the intra-coding of video, the detection of an edge and its direction is performed using only some of border pixels in a macroblock to determine an intra prediction mode and coding is performed in the determined intra prediction mode. Accordingly, the intra prediction mode is determined at high speed. In addition, the amount of calculation is reduced without deterioration of picture quality as compared to the conventional intra-coding method, in which cost functions in all of the 13 intra prediction modes are calculated and intra-coding is performed in one mode giving the least cost function among the 13 intra prediction modes.

Moreover, the present invention can improve the performance of H.264/Advanced Video Coding (AVC) encoders. Therefore, when the present invention is used in digital video products, digital multimedia broadcasting, etc., the competitiveness of products and services can be increased.

While the present invention has been-particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An intra-coding apparatus for coding an image comprised of a plurality of macroblocks, the intra-coding apparatus comprising:
an intra-frame prediction unit determining an intra prediction mode using border pixels on borders between a current macroblock to be coded and adjacent macroblocks and generating a predicted macroblock corresponding to the current macroblock in the determined intra prediction mode;
a subtractor outputting a difference between the current macroblock and the predicted macroblock;
a transformation/quantization unit transforming the difference into a frequency band signal and quantizing the frequency band signal; and
a coding unit coding a quantization result.

2. The intra-coding apparatus of claim 1, wherein the adjacent macroblocks are macroblocks that are coded and reconstructed prior to the current macroblock.

3. The intra-coding apparatus of claim 2, wherein the intra-frame prediction unit comprises:
an edge detector detecting whether the border pixels include an edge;
a prediction mode determiner determining a first prediction mode for border pixels having a first magnitude when any edge is detected and determining a second prediction mode for border pixels having a second magnitude when no edge is detected;
an edge direction calculator calculating a cost function reflecting a difference between values of border pixels in the current macroblock on a border between the current macroblock and one of the adjacent macroblocks and values of corresponding border pixels in the one adjacent macroblock with respect to each of a plurality of edge directions corresponding to one of the first and second prediction modes;
an intra prediction mode determiner determining an edge direction giving a least cost function as the intra prediction mode; and
a predicted macroblock generator generating the predicted macroblock in the intra prediction mode.

4. The intra-coding apparatus of claim 3, wherein the edge detector comprises:
a vertical edge detector outputting a largest value among absolute values of differences between values of vertically adjacent pixels including border pixels in the current macroblock and corresponding border pixels in an upper macroblock among the adjacent macroblocks among the border pixels; and
a horizontal edge detector outputting a largest value among absolute values of differences between values of horizontally adjacent pixels, including border pixels in the current macroblock and corresponding border pixels in a left macroblock among the adjacent macroblocks, among the border pixels.

5. The intra-coding apparatus of claim 4, wherein the prediction mode determiner determines the second prediction mode when the largest values respectively output from the vertical edge detector and the horizontal edge detector are less than a first threshold value and a second threshold value, respectively, and otherwise the prediction mode determiner determines the first prediction mode.

6. The intra-coding apparatus of claim 4 or 5, wherein when the first prediction mode is determined, the edge direction calculator calculates cost functions in edge directions respectively corresponding to modes 0, 3, 4, 5, 6, and 7 in an intra 4×4 prediction mode using the vertically adjacent pixels and cost functions in edge directions respectively corresponding to modes 1 and 8 in the intra 4×4 prediction mode using the horizontally adjacent pixels.

7. The intra-coding apparatus of claim 4 or 5, wherein when the second prediction mode is determined, the edge direction calculator calculates cost functions in edge directions respectively corresponding to modes 0, 1, 2, and 3 in an intra 16×16 prediction mode using the border pixels.

8. An intra-coding method for coding an image comprised of a plurality of macroblocks, the intra-coding method comprising the operations of:
detecting whether border pixels on borders between a current macroblock to be coded and adjacent macroblocks include an edge; calculating an edge direction in the border pixels in a prediction mode determined according to a result of the detection and determining an intra prediction mode based on a result of the calculation;
generating a predicted macroblock corresponding to the current macroblock in the intra prediction mode; and
calculating a difference between the current macroblock and the predicted macroblock and coding the calculated difference.

9. The intra-coding method of claim 8, wherein the adjacent macroblocks are macroblocks that are coded and reconstructed prior to the current macroblock.

10. The intra-coding method of claim 9, wherein the operation of detecting whether the border pixels include an edge comprises:
outputting as a first value a largest value among absolute values of differences between values of vertically adjacent pixels including border pixels in the current macroblock and corresponding border pixels in an upper macroblock among the adjacent macroblocks among the border pixels;
outputting as a second value a largest value among absolute values of differences between values of horizontally adjacent pixels including border pixels in the current macroblock and corresponding border pixels in a left macroblock among the adjacent macroblocks among the border pixels; and
determining that the border pixels do not include any edge when the first and second values are less than a first threshold value and a second threshold value, respectively.

11. The intra-coding method of claim 10, wherein when the current macroblock is located at a first row or a first column of the image, adjacent border pixels in one of the upper and left macroblocks are set to a predetermined DC value.

12. The intra-coding method of claim 9, wherein the operation of calculating the edge direction and determining the intra prediction mode comprises:
calculating a cost function reflecting a difference between values of border pixels in each of a plurality of edge directions in a pixel unit size changing according to existence or non-existence of an edge; and determining a prediction mode, which corresponds to an edge direction giving a least cost function, as the intra prediction mode.

13. The intra-coding method of claim 12, wherein when the border pixels include an edge, the plurality of edge directions comprise directions respectively corresponding to modes 0, 3, 4, 5, 6, and 7 in an intra 4×4 prediction mode with respect to vertically adjacent pixels including border pixels in the current macroblock and corresponding border pixels in an upper macroblock among the adjacent macroblocks among the border pixels and directions respectively corresponding to modes 1 and 8 in the intra 4×4 prediction mode with respect to horizontally adjacent pixels including border pixels in the current macroblock and corresponding border pixels in a left macroblock among the adjacent macroblocks among the border pixels.

14. The intra-coding method of claim 12, wherein when the border pixels do not include an edge, the plurality of edge directions comprise directions respectively corresponding to modes 0, 1, 2, and 3 in an intra 16×16 prediction mode with respect to the border pixels.

15. A computer readable recording medium for recording a program for executing the intra-coding method of any one of claims 8 through 14.
